(19) United States
(12) Patent Application Publication
(10) Pub. No.: US 2022/0079261 A1
(43) Pub. Date: Mar. 17, 2022

(54) WHISTLE SHIELDS

(71) Applicant: Fox 40 International Inc., Hamilton (CA)

(72) Inventor: David Ronald Foxcroft, Hamilton (CA)

(73) Assignee: Fox 40 International Inc., Hamilton (CA)

(21) Appl. No.: 17/384,002

(22) Filed: Jul. 23, 2021

Related U.S. Application Data
(60) Provisional application No. 63/076,996, filed on Sep. 11, 2020.

(51) Int. Cl. A41D 13/11; G10K 5/00

(52) U.S. Cl. CPC A41D 13/11; G10K 5/00

(57) ABSTRACT

An apparatus is provided that include a pouch having an interior to which a whistle is attached in use. A body is included which, in combination with the pouch, defines a face mask, the body having an opening which communicates with the interior of the pouch.

### CROSS-REFERENCE TO RELATED APPLICATIONS

This applications claims priority to U.S. Provisional Patent Application Ser. No. 63/053,922, filed Jul. 20, 2020, and to U.S. Provisional Patent Application Ser. No. 63/076,996, filed Sep. 11, 2020; the contents of which are hereby incorporated by reference.

### FIELD OF THE INVENTION

The invention relates to the field of whistles.

### BACKGROUND

Referees and others involved in the field of sport often use whistles to, for example, stop play. The use of a whistle involves the delivery of air from the lungs to the whistle which poses the potential for viral matter to be expelled.

### SUMMARY OF THE INVENTION

Forming one aspect of the invention is apparatus for use with a whistle, the apparatus comprising: a pouch having an interior to which the whistle is attached in use; and a body which, in combination with the pouch, defines a face mask, the body having an opening which communicates with the interior of the pouch.

Forming another aspect of the invention is a pouch having a trimmed opening and adapted to house a whistle.

### BRIEF DESCRIPTION OF THE FIGURES

FIG. 1 shows an embodiment of the invention in use;

FIG. 2 shows the inside of the structure of FIG. 1;

FIG. 3 shows the outside of the structure of FIG. 1;

FIG. 4A is a pattern used for constructing the structure of FIG. 1;

FIG. 4B is another pattern used for constructing the structure of FIG. 1;

FIG. 5 shows another embodiment of the invention alongside a prior art whistle; and

FIG. 6 shows the structure of FIG. 5 assembled for use.

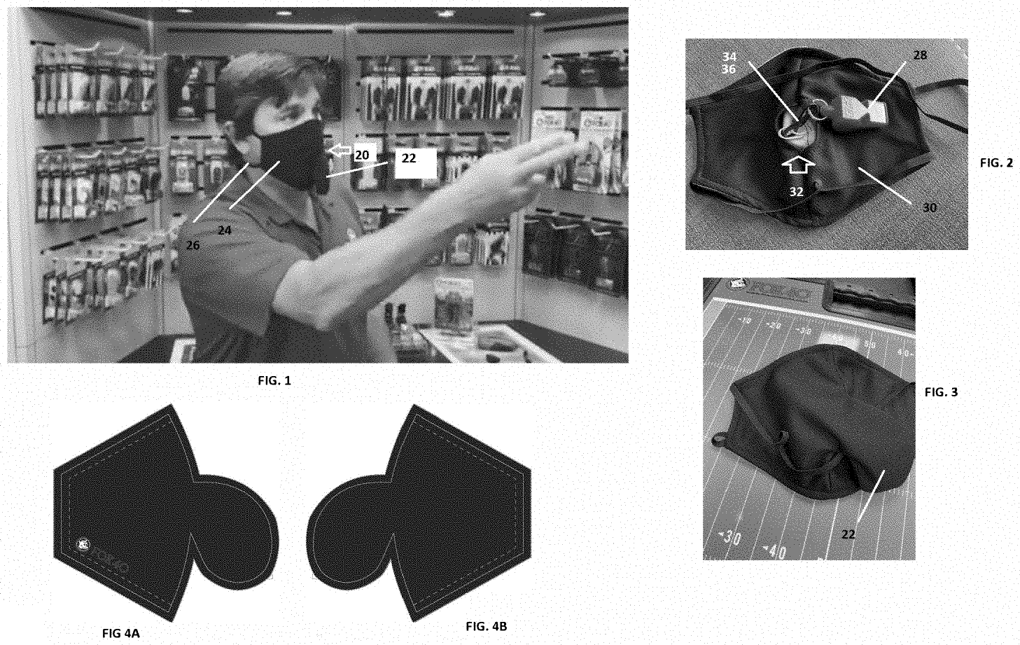

### DETAILED DESCRIPTION OF THE PREFERRED EMBODIMENTS

A whistle mask 20 according to an embodiment of the invention is shown in FIG. 1 in use.

Mask 20 is designed with a protective pouch 22 sewn to house a mouthblown whistle 28.

Mask 20 includes a mask body 24 that is similar to the body of a conventional mask but for trimmed opening 32 defined therein which communicates with the pouch 22.

Mask 20 has conventional straps 26 for engaging the ears of the user.

An elastic fabric hook 34 is sewn to the interior of the pouch 22 to hold a plastic whistle clip 36. The elastic hook 34 is flexible to allow the whistle clip 36 to manoeuvre safely when a whistle 28 is attached to prevent damage to the users teeth, lips or gums while using the invention of the whistle mask.

The whistle clip 36 is to secure the whistle 28 to the protective pouch 22 keeping the whistle 28 inside the pouch 22. After blowing, the whistle 28 can be released from the mouth, whereupon the whistle 28 drops into the pouch 22 allowing it to be available to the user after voicing instructions.

The protective pouch 22 containing the whistle is designed to not interfere with the user while the whistle 28 is not in use and keep the whistle readily available for the user to access the whistle quickly as needed. Having a whistle readily available to a user is important in a sports or safety situation.

The flexibility of the fabric hook and the flexible material of the cloth fabric of the protective pouch allows the whistle to be handled and manoeuvred safely into the mouth through the mouth opening of the interior of the mask. The whistle clip is designed so a whistle can be removed allowing the mask to be washed without the whistle attached

The apparatus allows users to safely use a mouth blown whistle 28 without contact to the whistle, facial area including nose or mouth, by the hands of the user.

The pouch 22 allows for the whistle 28 to be safely used and also readily available for the user to access.

The apparatus can be used by all users of mouthblown whistles including the following examples: referees and coaches in sport, lifeguards, hikers, police and school teachers.

Although a specific size and shape are shown, it will be apparent that variations are possible.

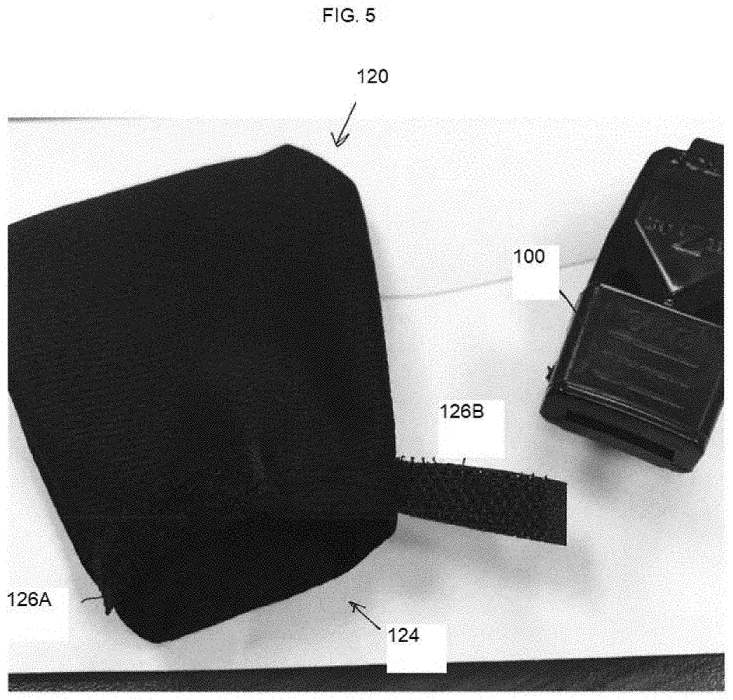

Another embodiment of the invention is shown in FIG. 5 and indicated with general reference numeral 120.

In this example, the pouch 120 is manufactured using 100% moisture resistant polyester fabric [density is 130 grams per square meter] to seal around the Cushioned Mouth Grip of a Fox 40™ whistle so it will not block the chambers.

This Pouch 120 is best used with a Fox 40 Classic CMG or Fox 40 Fuziun: a classic CMG is shown and indicated with reference number 100. In use, the pouch 120 reduces output by only about 1.5 dB, which is hard to detect by the human ear.

The pouch 120 comes with an elastic loop 22 to connect to a lanyard (not shown) and can also be used handheld.

The Pouch allows for the whistle to be safely used and also readily available for the user to access.

The pouch is for use by all users of mouthblown whistles including the following examples: referees and coaches in sport, lifeguards, hikers, police and school teachers. Having a whistle readily available to a user is important in a sports or safety situation

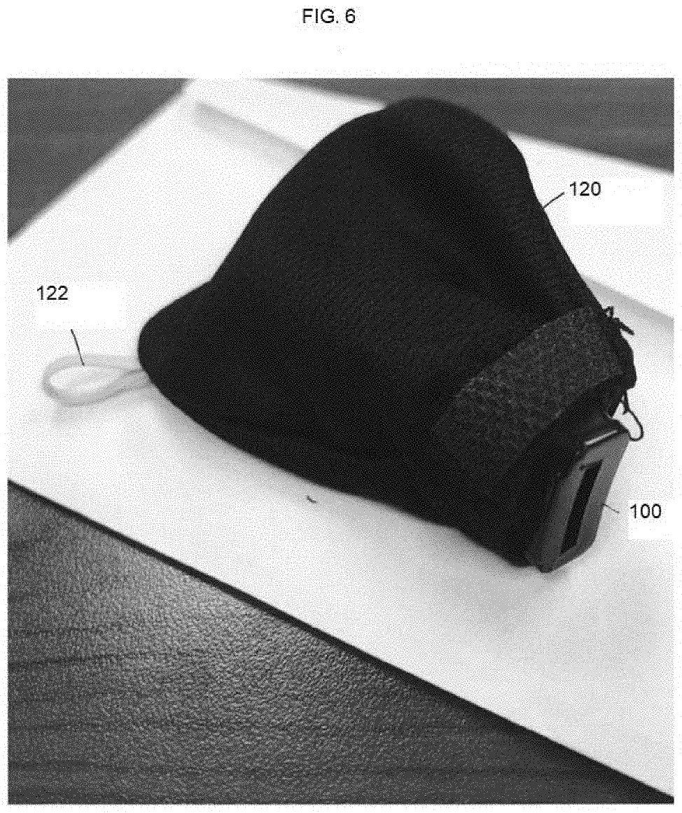

The 120 pouch has a trimmed opening 124. The opening has hook and loop straps 126A, 126B allowing for the pouch to be attached to the whistle as shown in FIG. 6. After use the pouch is easily removed from the Fox 40 whistle and is able to be washed and reused.

Whereas a specific whistle, pouch shape, fastener type and fabric type are described, it will be appreciated that variations are possible.

1. An apparatus for use with a whistle, the apparatus comprising:
a pouch having an interior to which the whistle is attached in use; and
a body which, in combination with the pouch, defines a face mask, the body having an opening which communicates with the interior of the pouch.

2. An apparatus for use with a whistle, the apparatus comprising:
a pouch having a trimmed opening and adapted to house a whistle.
